(19) United States
(12) Patent Application Publication
(10) Pub. No.: US 2002/0147712 A1
(43) Pub. Date: Oct. 10, 2002

(54) Method and apparatus for aggregating and dispatching information in distributed systems

(75) Inventor: Evan S. Huang, Cupertino, CA (US)

Correspondence Address: Silicon Valley Patent Agency, 7394 Wildflower Way, Cupertino, CA, 95014, US

(73) Assignee: XMLCITIES, INC., Milpitas, CA (US)

(21) Appl. No.: 10/118,759

(22) Filed: Apr. 8, 2002

Related U.S. Application Data
(60) Provisional application No. 60/282,608, filed on Apr. 9, 2001.

(51) Int. Cl. G06F 7/00

(52) U.S. Cl. 707/3

(57) ABSTRACT

Techniques for exchanging resource information in distributed systems are disclosed. To facilitate the information exchange, a subscription procedure is performed between an information aggregation system and an information dispatch system. During the subscription procedure, the information aggregation system provides/receives a guideline of information adaptation to/from the information dispatch system. The guideline ensures efficient information exchange between the systems. During the information aggregation phase, the aggregation system sends out query messages to each of its subscribed information dispatch systems. If the aggregation system receives a guideline from a particular dispatch system, it will adapt its local query into the dispatch system's format before sending out the query to that system and it will also convert the query results into its local format. Otherwise, the information dispatch system is responsible for information format for the query messages and the query results.

### CROSS REFERENCE TO RELATED APPLICATION

This application claims the benefits of US provisional application No.: 60/282,608, and entitled “Method and apparatus for aggregating and dispatching information between distributed systems,” filed on Apr. 9, 2001, which is hereby incorporated by reference for all purposes. This application is also related to co-pending U.S. patent application Ser. No. 09/754,969, entitled “Method and apparatus for utilizing document type definition to generate structured documents,” which is hereby incorporated by reference.

### BACKGROUND OF THE INVENTION

1. Field of the Invention

The present invention generally relates to the area of exchanging information between computers over a data network, and particularly relates to method and apparatus for aggregating and dispatching information in distributed systems.

2. Description of the Related Art

In a general sense, a “portal” is a door or entrance, especially a grand or imposing one. Portal is a term for a World Wide Web site that is or proposes to be a major starting site for users when they get connected to the World Wide Web, or that users tend to visit as an anchor site. Such a portal site is typically represented as a page that presents organized or collected information according to a preferred subject matter or type of services being offered.

A hotel portal, such as www.hotels.com, provides hotel reservation service across selected countries, regions or cities. The hotel portal not only provides travelers the convenience of making reservation on-line from a number of available hotels, motels or lodges but facilitate automatic reservation capability for hotels large or small that do not have their own on-line resource management systems or intend to expand their marketing. Typically, reservation information (such as availability of rooms) for a hotel is dynamically updated in the database. For example, a room available at a time could be reserved anytime. To avoid conflict between hotel portals, a hotel usually subscribes to only one hotel portal or allocates a certain number of rooms for each of the subscribed hotel portals. As a result, the allocated rooms being reserved through a subscribed hotel portal is largely relied upon the success of the subscribed hotel portal. Very often, one group of rooms allocated for one hotel portal are all booked up while another group of rooms are barely booked, resulting in disappointing sales to the hotel. Moreover, a hotel portal needs to host hundreds of hotels to attract users, which will require tremendous effort to build up an infrastructure to support and maintain such a service.

One approach is to let each hotel manage its own resources. As such, the hotel has the freedom to subscribe to different portals while the hotel portal is not limited to provide information from hosted hotels. When each hotel has the freedom to store its information in a unique way and the reservation information is updated constantly, there are at two main challenges for such distributed systems. First, the information aggregation system (e.g. a hotel portal or a travel agent) needs to retrieve dynamic and non-uniform information from information dispatch systems (e.g. hotel sites). Secondly, an information dispatch system (e.g. a hotel site) needs to support multiple information aggregation systems with different query formats. Such approach may be utilized or adopted in areas other than the hotel reservation system.

Thus, there is a need for a mechanism to facilitate aggregating and/or dispatching information in distributed systems.

### SUMMARY OF THE INVENTION

The present invention pertains to methods and apparatus for aggregating information from one or multiple data sources and dispatching information to one or multiple aggregation systems. One of the features in the present invention is a mechanism to provide requested information from a data source efficiently and, perhaps, in real time. The mechanism enables an information aggregation system to receive responses from information dispatch systems directly so that the information provided thereto is always synchronized in a data source (i.e. an information dispatch system).

According to one aspect of the present invention, to facilitate information exchange, there is a subscription procedure between an information aggregation system and an information dispatch system. During the subscription procedure, the information aggregation system receives a communication address, e.g., URI, from the information dispatch system. Furthermore, the information aggregation system provides/receives a guideline of information adaptation to/from the information dispatch system. The guideline ensures efficient information exchange between the systems. During the information aggregation phase, the aggregation system will send out query messages to each of its subscribed information dispatch systems through their communication addresses. If the aggregation system receives a guideline from a particular dispatch system, it will adapt its local query into the dispatch system's format before sending out the query to that system and it will also convert the dispatch system's query results into its local format. Otherwise, the information dispatch system is responsible for information format adaptation for the query messages and the query results.

Objects and advantage together with the foregoing are attained in the exercise of the invention in the following description and resulting in the embodiments illustrated in the accompanying drawings.

### BRIEF DESCRIPTION OF THE DRAWINGS

These and other features, aspects, and advantages of the present invention will become better understood with regard to the following description, appended claims, and accompanying drawings where:

FIG. 1 shows a basic system configuration in which the present invention may be implemented in accordance with a preferred embodiment;

FIG. 2A illustrates an example of an information aggregation system, which retrieves homogeneous information from data sources;

FIG. 3 is an example of document type definitions (DTD) for a hotel subscription list of an information aggregation system;

FIG. 4 is an example of DTD for requesting hotel vacancy of an information aggregation system;

FIG. 5 illustrates an example of an information dispatch system;

FIG. 6A is an example of DTD for requesting hotel vacancy of an information dispatch system;

FIG. 6B is an example of an extensible markup language (XML) for requesting hotel vacancy of an information dispatch system;

FIG. 6C is an example of DTD for hotel vacancy result of an information dispatch system;

FIG. 6D is an example of an XML for hotel vacancy result of an information dispatch system;

FIG. 7A shows an example of extensible stylesheet transformation (XSLT) for converting an XML file based on the aggregation system's DTD in FIG. 4 into an XML file based on the local query DTD in FIG. 6A;

FIG. 7B illustrates an example of XSLT for converting an XML file like FIG. 6D to an XML file based on the DTD in FIG. 4;

FIG. 8 illustrates an example of an information aggregation system, which performs adaptation to communicate with non-homogeneous data sources;

FIG. 9 shows an example of cascade information aggregation systems;

FIG. 10 shows a hybrid information dispatch and aggregation system;

FIG. 11A shows a flowchart of an information aggregation system presenting document type definitions to an information dispatch system;

FIG. 11B shows a flowchart of aggregating and dispatching information between an information aggregation system and information dispatch systems according to one embodiment to the present invention; and

FIG. 11C shows a flowchart of aggregating and dispatching information between an information aggregation system and information dispatch systems according to another embodiment to the present invention.

### DETAILED DESCRIPTION OF PREFERRED EMBODIMENTS

In the following description, numerous specific details are set forth in order to provide a thorough understanding of the present invention. However, it will become obvious to those skilled in the art that the present invention may be practiced without these specific details. The description and representation herein are the common means used by those experienced or skilled in the art to most effectively convey the substance of their work to others skilled in the art. In other instances, well known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

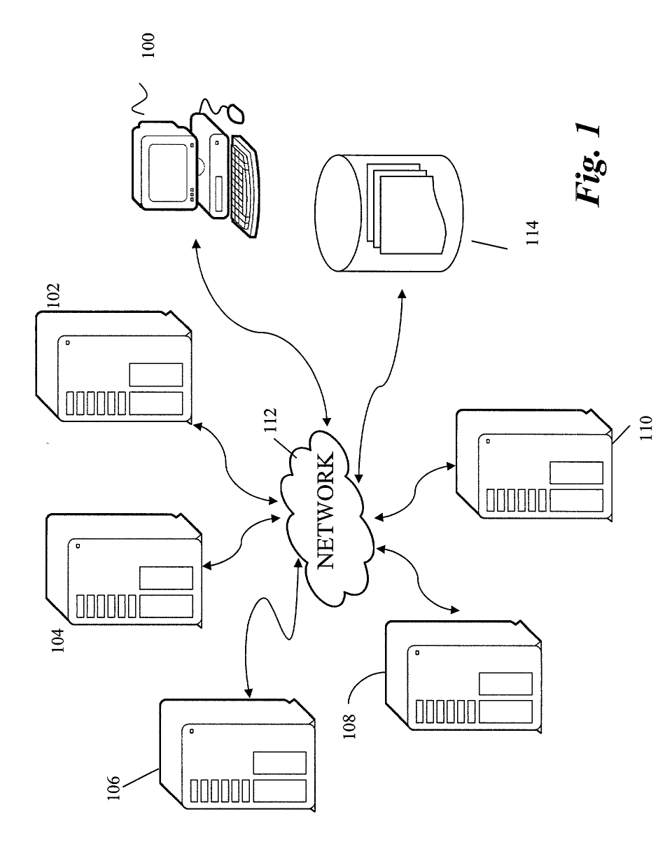

Referring now to the drawings, in which like numerals refer to like parts throughout the several views. FIG. 1 shows a basic system configuration in which the present invention may be implemented in accordance with a preferred embodiment. The representative computer system shown in FIG. 1 includes a workstation or personal computer (PC) 100 coupled to other devices through a data communication network 112. The personal computer 100 represents many types of terminal devices that may be used by users to inquire specific information, for example, availability of rooms in a hotel.

The representative computer system shown in FIG. 1 further includes several servers 102, 104, 106, 108, and 110 accessible through the network 112 to provide requested data and services to the users (through workstation 100). The servers typically include mass storage devices such as hard disk, CDROM, and other storage devices. Additionally, one or more of theses servers may access external mass storage devices 114 which are either directly connected to servers or are coupled through connections to network 112.

Each of the servers 102, 104, 106, 108, and 110 is configured to provide requested data in response to requests (data packets) received from network 112. Depending on implementation, each server 102, 104, 106, 108, and 110 may have a unique interface, query syntax, data format, security protocol, and the like. For example, servers, 102, 106, and 110, may be configured as a web server and responds to hypertext transfer protocol (HTTP) requests and generate responses therefore. In contrast other servers, 104 and 108, may use file transfer protocol (FTP) or other available transfer protocols to exchange files with servers, 102,106, and 110.

In a particular example, a server 102 or 104 implements a hotel web server that hosts a website having a predefined structure, access syntax and protocol. Other than providing general hotel information, each hotel website is designed to participate in an on-line reservation system and to provide vacancy information in response to queries received from on-line reservation system through network 112. A server 108 or 110 is configured to be a hotel portal web server that receives queries from users through network 112. Server 106 is shared by multiple information aggregation systems (e.g. a hotel portal or a travel agent) and information dispatch systems (e.g. a hotel website) that receives/generates queries in the same server as well as through network 112. For example, in response to a query of hotel vacancy for a particular location and duration, the hotel portal server may send out queries to hotel servers to request vacancy information and then display the results through network 112 to the request workstation 100.

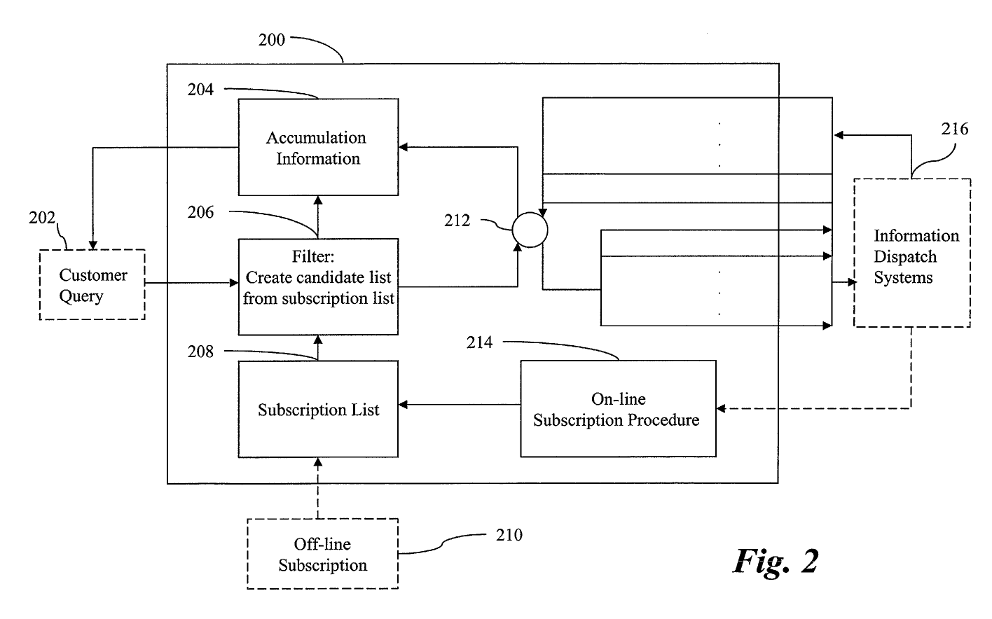

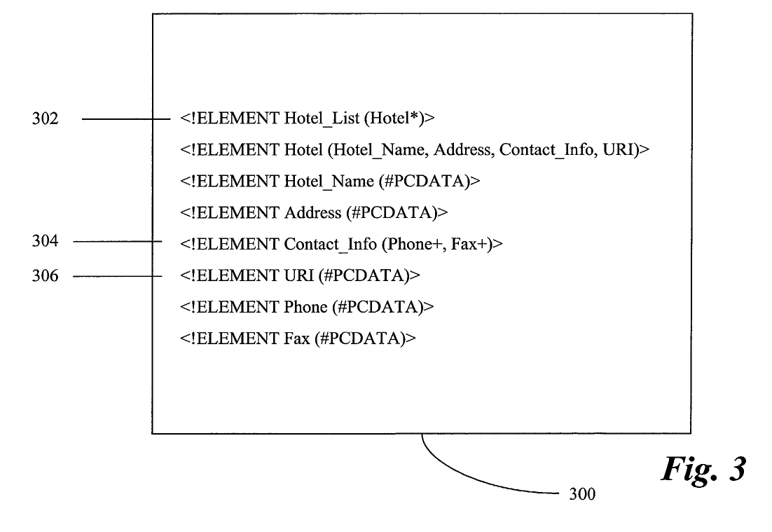

FIG. 2 shows an example of an information aggregation system 200. Before this system can provide services to its customer, it needs to build a subscription list 208 that lists all data sources (e.g. information dispatch systems) contracted to provide requested information when requested. To facilitate the exchange of the information between the information aggregation system 200 and each of the data sources, a data structure schema is provided by each of the data sources. As used herein, a data structure schema is rules set for expressing data, or alternatively, is vocabulary for expressing data's business rules. An example of a data structure schema, such as document type definitions (DTD), for a hotel portal's subscription list 300 is given in FIG. 3, where a hotel list 302 contains zero or more hotels and each hotel contains hotel information such as name, one or more phone and fax numbers 304, and a Universal Resource Identifier (URI) 306. Another example of a data structure schema may be the XML Schema proposed by the W3C organization. Other types or structures may be created for the data structure schema depending on implementation. In general, the URI is the communication address for the aggregation system to request information from the subscribed dispatch system.

The subscription procedure can be done either on-line 214 or off-line 210. The subscription list can be automatically filled by programs written by HTML form, Java Script, Java Servelet, CGI program, . . . etc, or be manually filled through telephone, fax, . . . etc. In this example, during the subscription procedure, a dispatch system will receive a guideline for information adaptation from the aggregation system 200. The dispatch system is responsible for adapting its local information structure into the information structure provided by the aggregation system. Since in the portal case, the aggregation system supports a long subscription list and the dispatch system only supports a limited number of portal sites, it is more efficient to distribute the adaptations to each of the information dispatch systems. As such, the information aggregation system 200 in the query phase will treat the information dispatch systems as homogeneous data sources.

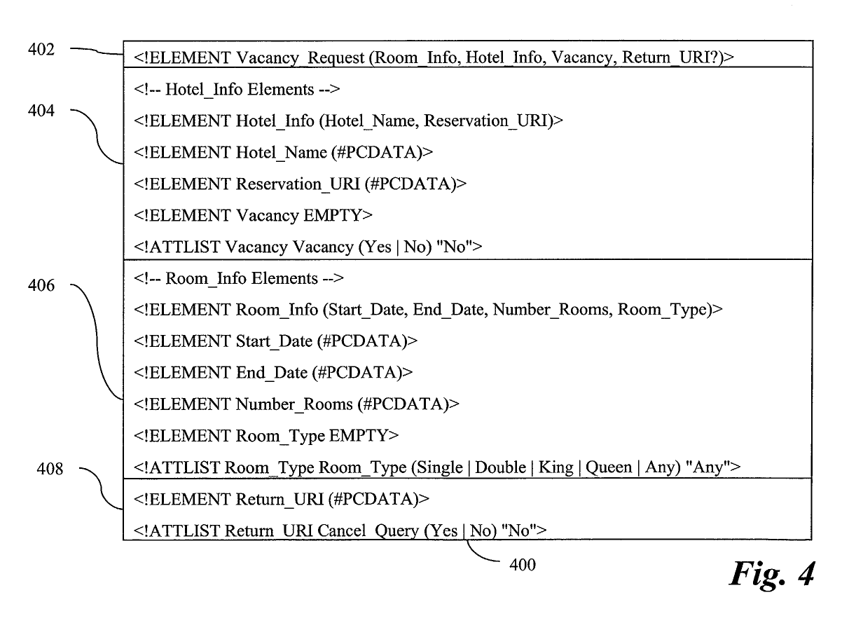

An example of document type definitions for a hotel vacancy request is given in FIG. 4. In this example, vacancy request 402 includes hotel information 404, room information 406 and other related information. Accordingly, the aggregation system will fill out Hotel_Name, Start_Data, End_Data, Number_Rooms, and Room_Type before sending the request to the information dispatch systems, e.g., system 200 of FIG. 2 and the corresponding information dispatch systems are responsible for filling out Reservation_URI and specifying Vacancy.

When an information aggregation system (e.g. a hotel portal) receives a query from a customer, it will first create a candidate list 206 by filtering out the subscription list with the customer query information such as using location in the customer query to match Address in the hotel portal DTD 300. Then the customer query and the candidate list will be sent to the communication unit 212. The communication unit will send out the query message with the provided information to each URI in the candidate list. The received information from the information dispatch systems is sent to the accumulation information unit 204, which will format the accumulated information and post it back to the requested customer.

The communication address from an information aggregation to a particular information dispatch system may not be the same as the one from the dispatch system back to the aggregation system. For a single communication address, a dedicated communication in the aggregation system port has to be opened during the query. In this case, the aggregation system has the control to terminate the communication. However, it is possible that, there is a long subscription list and/or there are many customers querying simultaneously, which causes the requested communication ports beyond the limit. As such, the queue of requesting communication ports may create a bottleneck for processing. According to one embodiment, the information dispatch system is configured to create a different communication port for sending back the query results. In this case, the aggregation system only needs to wait for the results pushed back from the dispatch system. Accordingly, the aggregation system is configured to provide a return communication address to the dispatch system.

An example of Return_URI 408 is given in FIG. 4. Based on the DTD, the Return_URI can be zero or one in the Vancancy_Request 402 to support single or double communication-address cases. It may be noted that the aggregation system does not necessarily have the control to terminate the query in the return communication-address case. The aggregation system can only send another request to the dispatch system for terminating the query as specifying the Cancel_Query attribute in 408. In order for the dispatch system to cancel a particular request, the Return_URI has to have some decorations such as http://www.samplehotelportal.com/Return Request?customer id=112233&customer request=1234 to uniquely identify the query. Furthermore, those decorations are also important for the aggregation system to associate the query results to a particular customer with a particular request.

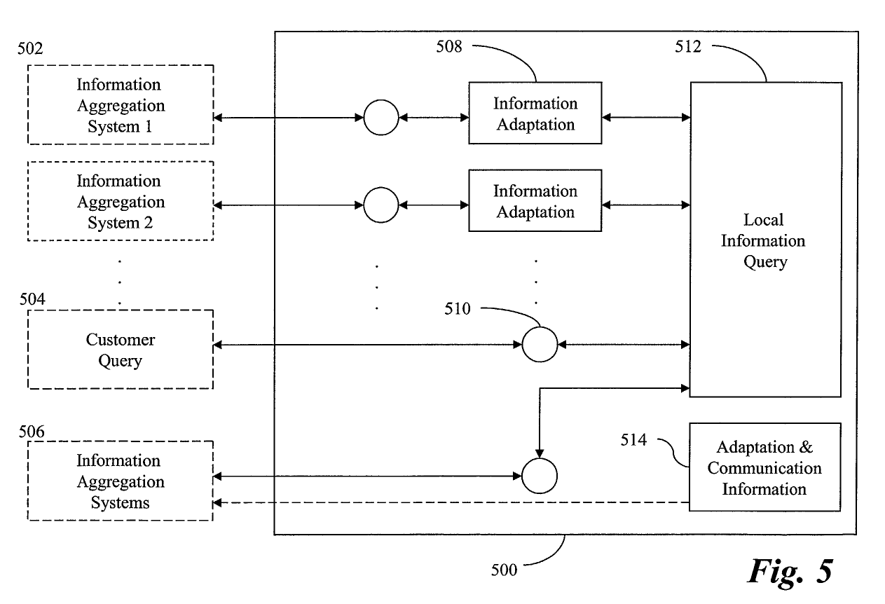

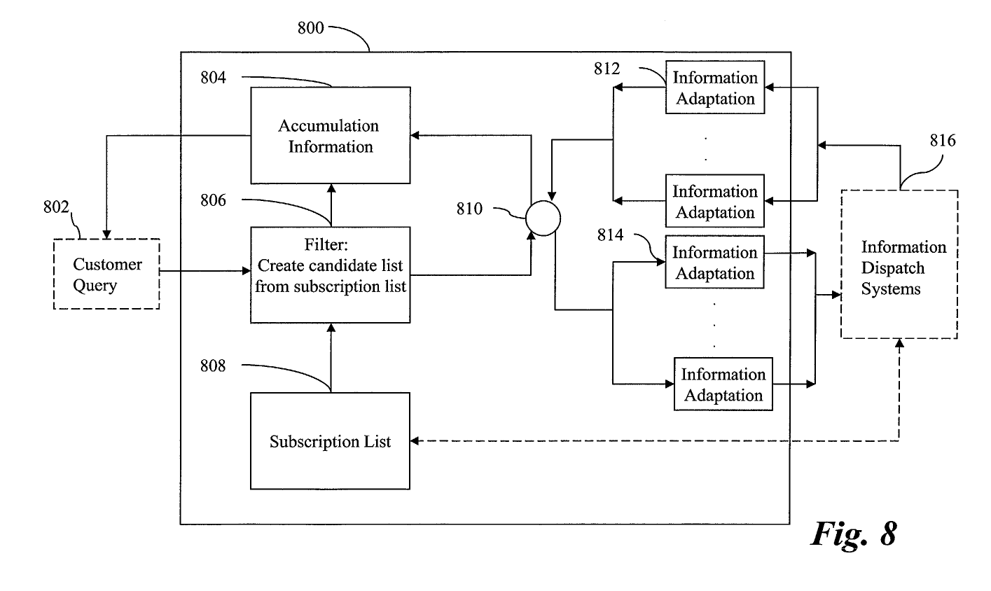

FIG. 5 illustrates an example of an information dispatch system 500 that is configured to handle a direct customer query 504 as well as the queries from the information aggregation systems. And the query from the information aggregation system can either be in the format of the dispatch system 506 or in the format of the aggregation system 502 which needs further adaptation. For the information aggregation systems 506 requiring no adaptation within the dispatch system, they need to first download the adaptation information and communication address 514 from the dispatch system. In the hotel case, travel agents are more geared to this type of information aggregation systems. Since there are many travel agents who may want to request information from a hotel site, it is much suitable for a hotel site to provide communication addresses dedicated for such requests than to perform the adaptations for each travel agent's request. An example of such type aggregation system will be discussed in FIG. 8. On the other hand, the aggregation system 502 is assumed for a hotel portal as shown in FIG. 2.

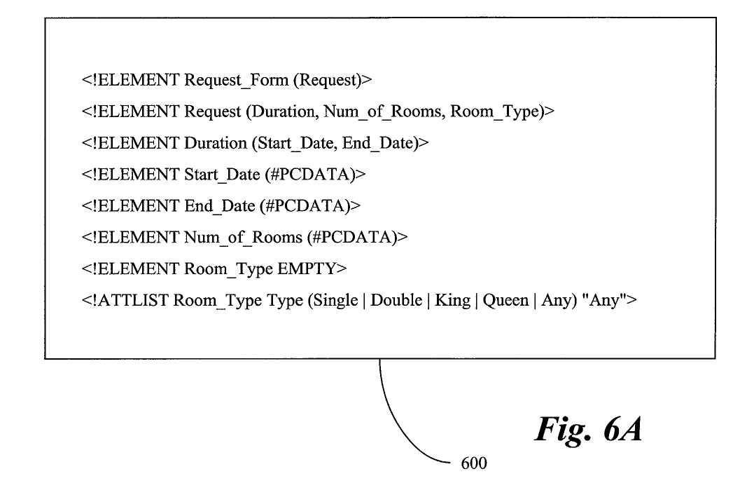

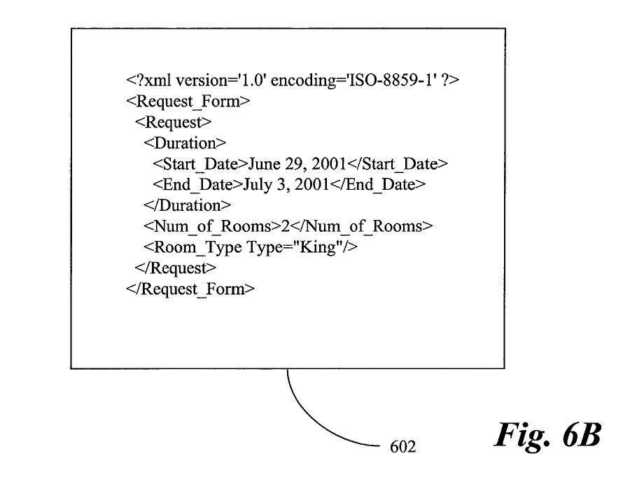

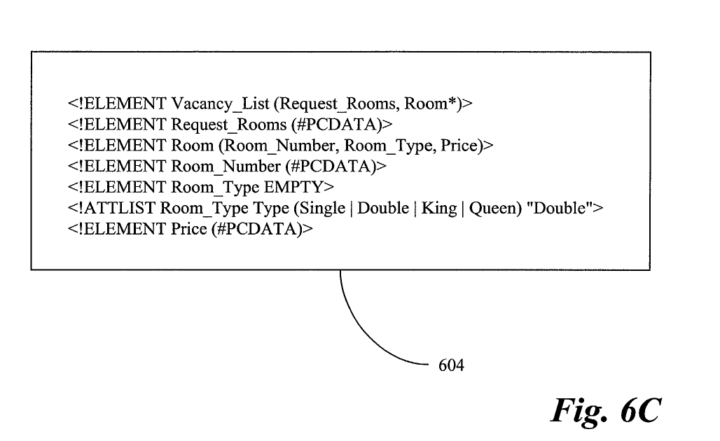

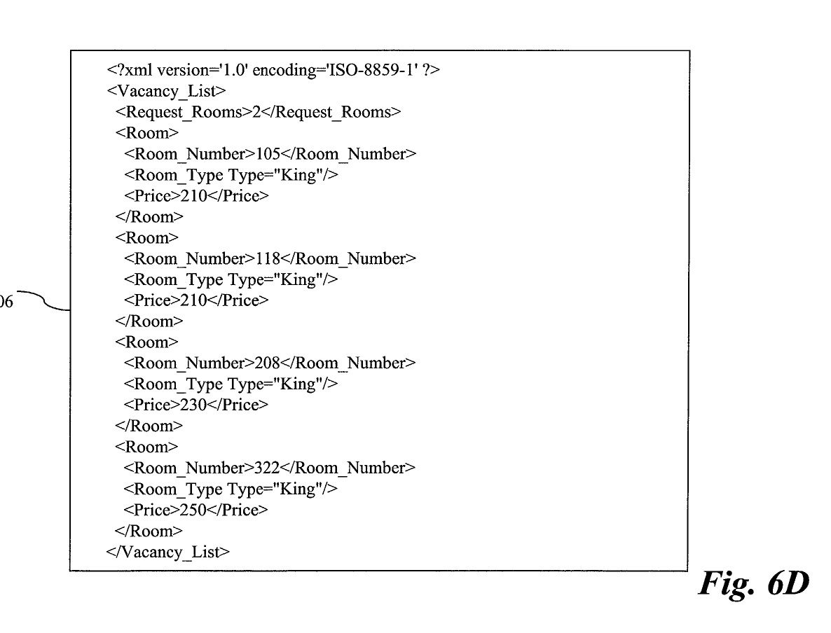

An example of document type definitions (DTD) for the hotel vacancy request 600 of the dispatch system from customers 504 or the aggregation system 506 is given in FIG. 6A. A sample extensible markup language (XML) file 602 with the vacancy request DTD 600 is shown in FIG. 6B. In this particular example, the XML file is the input query for the local information query system 512. An example of document type definitions (DTD) for resultant vacancy list 604 from the local information query system 512 is given in FIG. 6C. And a sample XML 606 for the vacancy list is shown in FIG. 6D. The request result XML 606 will be sent back to the information aggregation system 506. For the customer query 504, the resultant XML 606 is formatted by customer communication unit 510 and is posted back to the requested customer.

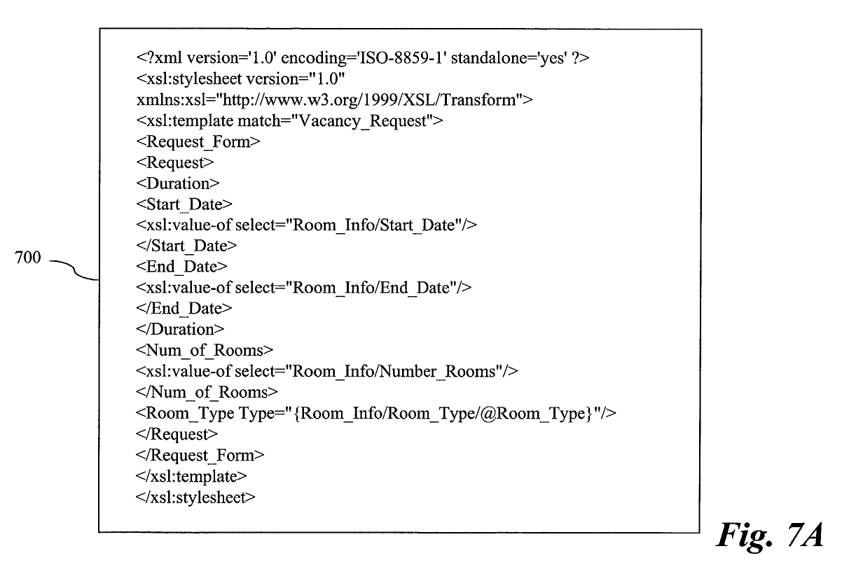

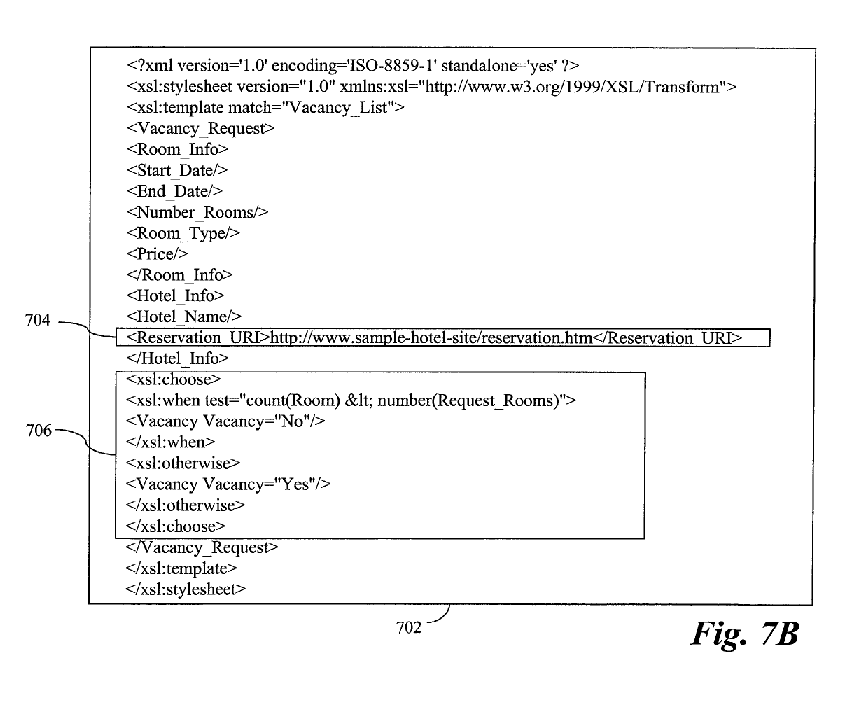

To handle a query from an information aggregation system 502 requiring adaptation, the query is adapted before sending to the local information query system 512. Since the local information query system 512 can only handle a local query, a query from a particular information aggregation system has to be first transferred into the local query. An example of extensible stylesheet transformation (XSLT) to convert an XML file based on the aggregation system's DTD 400 into an XML file based on the local query DTD 600 is shown in FIG. 7A. Furthermore, the query result from the local information query system also needs to be transferred back to the query result for the aggregation system. FIG. 7B illustrates an example of XSLT 702 to convert an XML file like 606 back to an XML file based on the DTD 400. In particular, a static reservation URI is specified in 704 and a conditional <xsl:choose> to specify the vacancy based on the number of available rooms and the number of request rooms is given in 706.

FIG. 8 shows another example of an information aggregation system 800, which performs information adaptation internally. In the hotel case, this type information aggregation system is for travel agents and it is responsible for the information adaptation while retrieving information from hotel sites. Before this system can provide services to its customer, it also needs to build a subscription list 808, which is similar to the example given in 300 of FIG. 3. For building the subscription list, the aggregation system has to obtain a communication address, like URI, and a guideline for information adaptation from each of the subscribed dispatch systems. During the query phase, the aggregation system will adapt its local query into the dispatch systems' format 814 and convert the query results from the dispatch systems back to its local format 812. Examples of information adaptation are similar to the XSLTs given in FIG. 7.

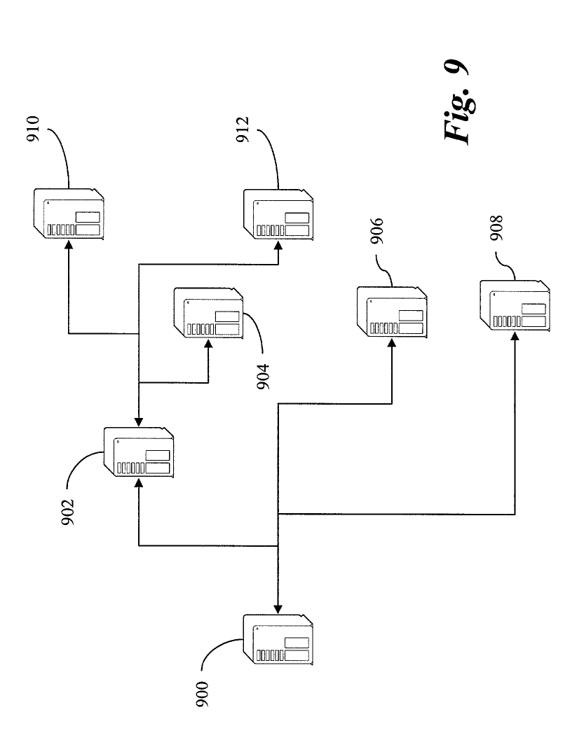

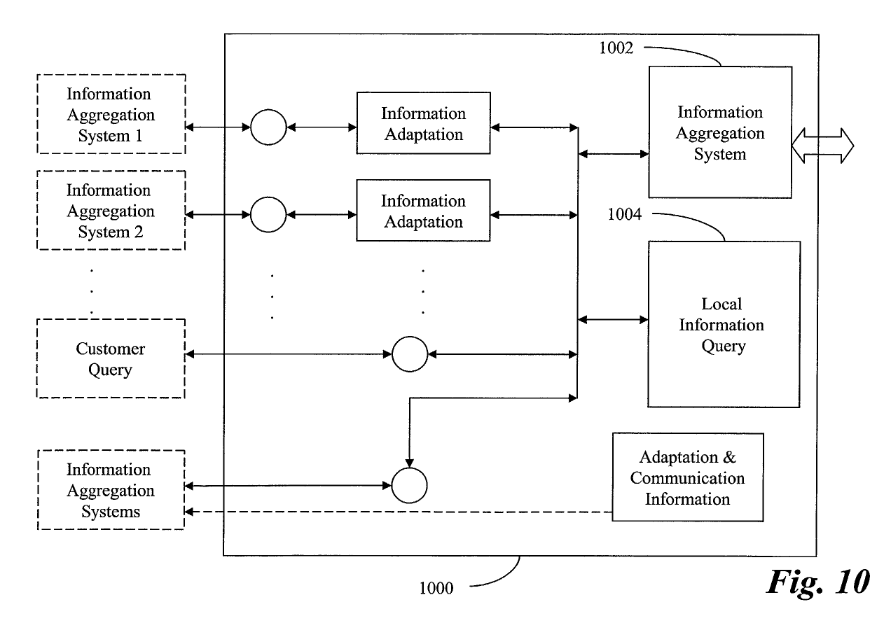

An information aggregation system can also be an information dispatch system for other aggregation systems. FIG. 9 shows an example that the information aggregation system 902 along with two information dispatch systems 906 and 908 are subscribed information dispatch systems for the information aggregation system 900. When a query from system 900 to system 902, system 902 will convert the query into its format and pass on to its subscribed information dispatch systems 904, 910, and 912 for information. And the query result from system 902 will be adapted to the format for system 900 before sending it back. Furthermore, the system 902 can be a hybrid information dispatch and aggregation system as shown in FIG. 10, where an information aggregation system is treated as an internal unit for information query.

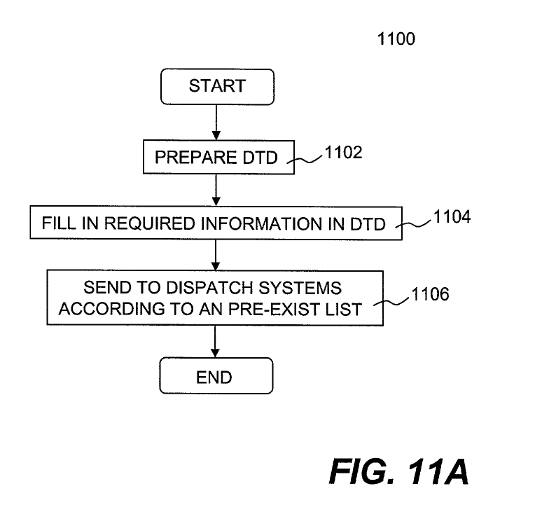

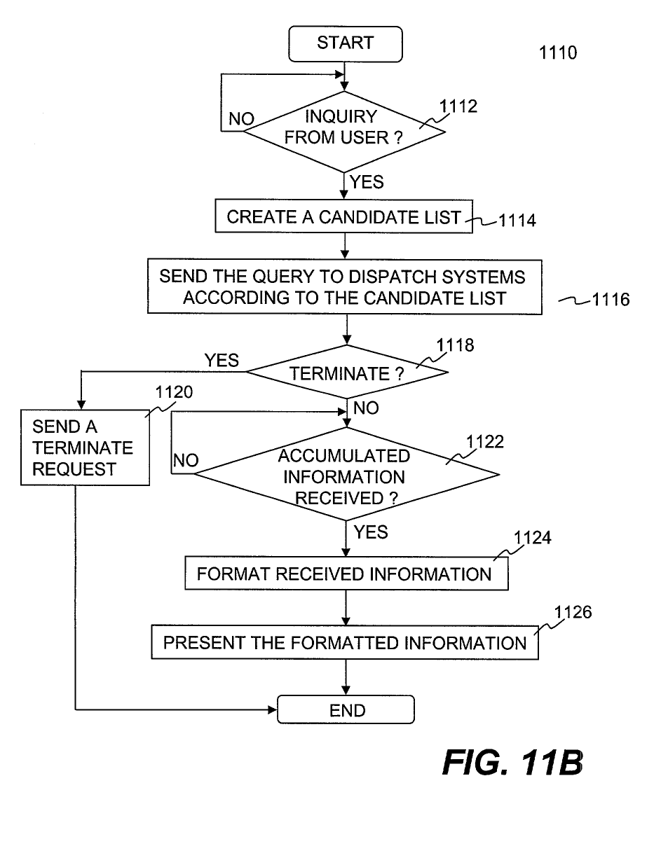

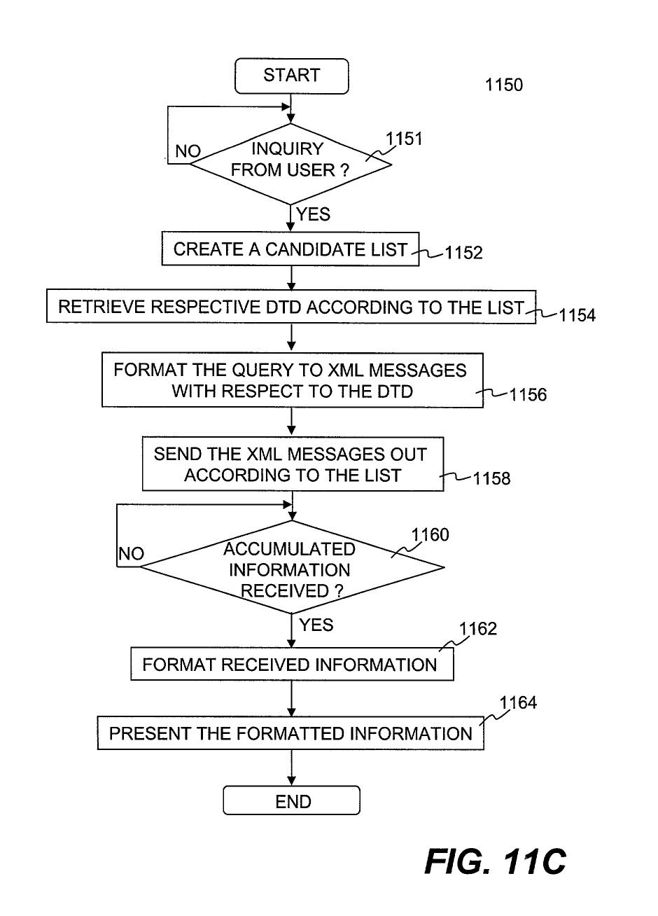

FIG. 11A shows a flowchart 1100 of an information aggregation system presenting document type definitions to an information dispatch system. At 1102, the information aggregation system prepares document type definitions (for example, FIG. 3). According to one embodiment, a document type definition (DTD) can be associated with an XML message to allow a more detailed set of constraints to be applied to the structure of a message. These constraints are expressed in the form of a document type definition (DTD) that can be used to:

restrict the context in which certain elements can appear

restrict the set of attributes that can be associated with a specific element

restrict the set of values that can be assigned to an attribute

provide default or fixed values for attributes whose values do not change from message to message

extend XML's default set of entity names that can be used to identify special characters, to import part of the message from other files, or to provide predefined contents for parts of the message

restrict the data type of a particular element or entity to match a predefined notation.

Before sending such DTD to an information dispatch system, the information aggregation system normally fills in its own necessary information at 1104. At 1106, the DTD is sent to each of the information dispatch systems according to an existing list listing all data sources (i.e. information dispatch systems) contracted to provide requested information when asked.

Referring now to FIG. 11B, there is shown a flowchart 1110 of aggregating and dispatching information between an information aggregation system and information dispatch systems, assumed that the information dispatch system has already received the DTD from the information aggregation system. The process or flowchart 1110 is based on an embodiment of the present invention and may be understood in conjunction with FIG. 1 to FIG. 4

Similar to many portal sites, the information aggregation system awaits an inquiry from a user. When a user desires to gather information about a query from a number of resources, the user provides specific information of the query. For example, in the hotel reservation applications, the user desires to see availability of a number of hotels within a determined driving range in a selected city during specified days. When such query is received over the network (from the user), the information aggregation system is configured to create a candidate list at 1114 from the pre-existing list according to the query. For example, there are 1000 hotels contracted to provide vacancy information, only 25 of those are located within the driving range specified by the user. According to one embodiment, the candidate list includes a list of URIs, each for one of the selected information dispatch systems. After the candidate list is created, the process 1110 proceeds with dispatching the query to the selected information dispatch systems, respectively.

In some cases, the user may decide to abandon the query. At 1118, the process 1110 awaits if there is any of such cancellation. If the information aggregation system does receive a cancellation, the process 1110 moves to 1120 where a terminate request is generated, which may suspend subsequent processes. If no such cancellation is ever received or such cancellation comes very late, the process 1110 moves to 1122 to await responses from the contacted information dispatch systems. In general, block 1122 repeats itself till all expected responses are received or a predetermined time expires.

At 1124, the responses are received and to be formatted according to a presentation requirement. According to one embodiment, the information aggregation system provides HTML presentations to the user. Accordingly, a stylesheet, possibly generated from the HTML presentations, is used. The responses are XML messages according to one embodiment. When an XML document parser encounters a document type declaration at the start of an XML message, it will automatically check the sequence in which elements occur within the XML message conform to the constraints expressed in the element declaration for the containing element within the DTD. It may also check that the values of any attributes conform to the restrictions declared in any attribute list declarations associated with the element name within the DTD. In addition it will check that any attribute declared with a fixed or required value in the DTD is present and has the required type of value. If a required attribute is not present, but has been assigned a default value in the DTD, the parser will automatically add the attribute name and default value to the list of attributes associated with the element in the message. Where an entity reference, consisting of the entity name preceded by & and followed by a semicolon (;), is encountered the reference will be replaced by the replacement text specified in the entity declaration with the specified name. If this entity has been associated with a specific notation then the name assigned to the notation will be searched for in the notation declarations in the DTD, and the data will be passed to the process(es) identified by the notation declaration with that name (providing the application has a mechanism for processing data of that type).

As a result, a presentation source (e.g. in HTML) is generated at 1124. The presentation source can then be presented to the user at 1126 in a browsing application (e.g. Microsoft Internet Explorer).

Referring now to FIG. 11C, there is shown a flowchart 1150 of aggregating and dispatching information between an information aggregation system and information dispatch systems according to another embodiment to the present invention. The flowchart or process 1150 may be further understood in conjunction with FIG. 5-FIG. 10.

The information aggregation system may be operated by a small business that may not be able to demand an information dispatch system to provide data sources in a format desirable by the business. In other words, such information dispatch system may support a large number of business entities, each may have a different presentation requirement. Examples of such business may include, not be limited to, a travel agency or one or more travel agents.

At 1151, the process 1150 awaits an inquiry from a user (e.g., a travel agent for a traveler). When the user desires to gather information about a query from a number of resources, the user provides specific information of the query. For example, in the hotel reservation applications, the user desires to see availability of a number of hotels within a determined driving range in a selected city during specified days. When such query is received, the information aggregation system is configured to create a candidate list at 1152 from a pre-existing list according to the query. For example, there are 1000 hotels contracted to provide vacancy information, only 25 of those are located within the driving range specified by the user. According to one embodiment, the candidate list includes a list of URIs, each for one of the selected information dispatch systems.

At 1154, respective document type definitions (DTD) are retrieved for each of the candidates in the candidate list. The DTD may be preloaded in the information aggregation system or retrieved in time from a corresponding information dispatch system. Given the DTD, the query is converted at 1156 to an XML message or a message in a markup language substantially similar to what is being used in the corresponding information dispatch system. Such message is then sent over a network to the information dispatch system at 1158. If there are N candidates in the candidate list, there would be N such messages, each is sent to one of the N candidates, namely, N information dispatch systems.

At 1160, the process 1150 awaits the responses from the identified information dispatch systems. It is assumed that each of the responses is received. The received responses are in XML or in the markup language used in the corresponding information dispatch system. At 1162, the received information (i.e., the responses) is formatted in accordance with a stylesheet suitable for presentation in the information aggregation system. According to one embodiment, the information aggregation system is configured to display HTML sources. Accordingly, the received information is converted to an HTML source according to the DTD. The HTML source is then presented to the user at 1164.

The invention is preferably implemented by software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

There are numerous features, benefits and advantages in the present invention. One of them is a mechanism to provide requested information from a data source efficiently and in real time, which finds a particular interest in online hotel reservation systems. The mechanism enables an information aggregation system to receive responses from information dispatch systems directly so that the information provided thereto is always synchronized in a data source (i.e. an information dispatch system). Other features, benefits and advantages can be readily appreciated by those skilled in the art from the foregoing description of the present invention.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

What is claimed is:

1. A method for exchanging information, the method comprising:
creating a candidate list from an existing list upon receiving a query over a network;
sending the query to a selected number of data sources over the network according to the candidate list;
receiving respective responses from the data sources, wherein each of the respective responses is prepared at one of the data sources according to a data structure schema previously received in accordance with a data requirement;
formatting the respective responses according to a presentation requirement; and
responding to the query by displaying the combined respective responses.

2. The method as recited in claim 1, wherein the existing list includes all data sources contracted to provide information when requested, and wherein the candidate list is derived from the existing list in accordance with the query.

3. The method as recited in claim 2, wherein each of the data sources maintains data source in a first markup language.

4. The method as recited in claim 3, wherein the data requirement is in accordance with the presentation requirement.

5. The method as recited in claim 3, wherein each of the respective responses is prepared in the first markup language.

6. The method as recited in claim 5, wherein the presentation requirement is a stylesheet in accordance with the first markup language, and wherein said formatting the respective responses comprises transforming the respective responses to a presentation source in a second markup language according to the stylesheet.

7. The method as recited in claim 6, wherein the first markup language is selected from a group consisting of Hypertext Markup Language (HTML), Extensible Markup Language (XML), Standard Generalized Markup Language (SGML) and Wireless Markup Language (WML).

8. The method as recited in claim 7, wherein the second markup language is selected from a group consisting of Hypertext Markup Language (HTML), Extensible Markup Language (XML), Standard Generalized Markup Language (SGML) and Wireless Markup Language (WML).

9. The method as recited in claim 1 further comprising sending a terminate request to the selected number of data sources when the query is meant to be cancelled.

10. The method as recited in claim 1, wherein each of the data sources is (i) an information dispatch system, (ii) a combination of an information dispatch system and an information aggregation system, or (iii) an information aggregation system.

11. The method as recited in claim 1, wherein said sending the query to a selected number of data sources comprises sending a request to each of the selected number of data sources query, wherein the request includes the query and a returning communication address for receiving a response to the query.

12. The method as recited in claim 11, wherein the returning communication address is different from a communication address from which the request is sent.

13. A method for exchanging information, the method comprising:
creating a candidate list from an existing list upon receiving a query, the candidate list including at least a data source providing relevant information pertaining to the query;
retrieving a data structure schema according to the data source in the candidate list, wherein the data source maintains the relevant information in a first markup language;
formatting the query into a message in the first markup language;
sending the message to the data source;
receiving a response from the data source, wherein the response is in the first markup language;
converting the response into a presentation source in a second markup language according to a presentation requirement; and
responding to the query by displaying the presentation source.

14. The method as recited in claim 13, wherein the existing list includes all data sources contracted to provide information when requested, and wherein the candidate list is derived from the existing list in accordance with the query.

15. The method as recited in claim 14, wherein the presentation requirement is a stylesheet in accordance with the second markup language.

16. The method as recited in claim 15, wherein the first markup language is selected from a group consisting of Hypertext Markup Language (HTML), Extensible Markup Language (XML), Standard Generalized Markup Language (SGML) and Wireless Markup Language (WML).

17. The method as recited in claim 15, wherein the second markup language is selected from a group consisting of Hypertext Markup Language (HTML), Extensible Markup Language (XML), Standard Generalized Markup Language (SGML) and Wireless Markup Language (WML).

18. The method as recited in claim 15, wherein the presentation requirement is a stylesheet in accordance with the second markup language.

19. The method as recited in claim 13, wherein the data source is (i) an information dispatch system, (ii) a combination of an information dispatch system and an information aggregation system, or (iii) an information aggregation system.

20. A system for exchanging information, the system comprises:
memory for storing executable code as a software module;
a processor, coupled to the memory, when instructed to execute the executable code, causing the software module to perform operations of:
creating a candidate list from an existing list upon receiving a query over a network;
sending the query to a selected number of data sources over the network according to the candidate list;
receiving respective responses from the data sources, wherein each of the respective responses is prepared at one of the data sources according to a data structure schema previously received in accordance with a data requirement;
formatting the respective responses according to a presentation requirement; and
responding to the query by displaying the combined respective responses.

21. The system as recited in claim 20, wherein the existing list includes all data sources contracted to provide information when requested, and wherein the candidate list is derived from the existing list in accordance with the query.

22. The system as recited in claim 21, wherein each of the data sources maintains data source in a first markup language.

23. The system as recited in claim 22, wherein the data requirement is in accordance with the presentation requirement.

24. The system as recited in claim 22, wherein each of the respective responses is prepared in the first markup language.

25. The system as recited in claim 24, wherein the presentation requirement is a stylesheet in accordance with the first markup language, and wherein said formatting the respective responses comprises transforming the respective responses to a presentation source in a second markup language according to the stylesheet.

26. The system as recited in claim 25, wherein the first markup language is selected from a group consisting of Hypertext Markup Language (HTML), Extensible Markup Language (XML), Standard Generalized Markup Language (SGML) and Wireless Markup Language (WML).

27. The system as recited in claim 26, wherein the second markup language is selected from a group consisting of Hypertext Markup Language (HTML), Extensible Markup Language (XML), Standard Generalized Markup Language (SGML) and Wireless Markup Language (WML).

28. The system as recited in claim 20, wherein each of the data sources is (i) an information dispatch system, (ii) a combination of an information dispatch system and an information aggregation system, or (iii) an information aggregation system.

29. The system as recited in claim 20, wherein said sending the query to a selected number of data sources comprises sending a request to each of the selected number of data sources query, wherein the request includes the query and a returning communication address for receiving a response to the query.

30. The system as recited in claim 29, wherein the returning communication address is different from a communication address from which the request is sent.

31. A system for exchanging information, the system comprises:
memory for storing executable code as a software module;
a processor, coupled to the memory, when instructed to execute the executable code, causing the software module to perform operations of:
creating a candidate list from an existing list upon receiving a query, the candidate list including at least a data source providing relevant information pertaining to the query;
retrieving a data structure schema according to the data source in the candidate list, wherein the data source maintains the relevant information in a first markup language;
formatting the query into a message in the first markup language;
sending the message to the data source;
receiving a response from the data source, wherein the response is in the first markup language;
converting the response into a presentation source in a second markup language according to a presentation requirement; and
responding to the query by displaying the presentation source.

32. The system as recited in claim 31, wherein the existing list includes all data sources contracted to provide information when requested, and wherein the candidate list is derived from the existing list in accordance with the query.

33. The system as recited in claim 32, wherein the presentation requirement is a stylesheet in accordance with the second markup language.

34. The system as recited in claim 33, wherein the first markup language is selected from a group consisting of Hypertext Markup Language (HTML), Extensible Markup Language (XML), Standard Generalized Markup Language (SGML) and Wireless Markup Language (WML).

35. The system as recited in claim 33, wherein the second markup language is selected from a group consisting of Hypertext Markup Language (HTML), Extensible Markup Language (XML), Standard Generalized Markup Language (SGML) and Wireless Markup Language (WML).

36. The system as recited in claim 33, wherein the presentation requirement is a stylesheet in accordance with the second markup language.

37. The system as recited in claim 31, wherein the data source is (i) an information dispatch system, (ii) a combination of an information dispatch system and an information aggregation system, or (iii) an information aggregation system.

38. A system for exchanging information, the system comprising:
a plurality of information dispatch systems, each coupled to a data network and maintaining relevant information in a first markup language;
an information aggregation system, coupled to the data network, keeping a plurality of data structure schemas, each of the schemas pertaining to the relevant information in one of the information dispatch systems, upon receiving a query, the information aggregation system configured to format the query into a message in the first markup language and send the message to one of the information dispatch systems, wherein requested information in the first markup language is retuned from the one of the information dispatch systems to the information aggregation system; and
wherein the information aggregation system converts the requested information into a presentation resource in a second markup language to respond to the query by displaying the presentation resource.
